(19) United States
(12) Patent Application Publication
(10) Pub. No.: US 2005/0049961 A1
(43) Pub. Date: Mar. 3, 2005

(54) Automated workflow and collaborative transaction management for making residential home mortgages

(76) Inventor: Corey J. Hansen, Austin, TX (US)

Correspondence Address: Raymond M. Galasso;Simon, Galasso & Frantz PLC, P.O. Box 26503, Austin, TX, 78755-0503, US

(21) Appl. No.: 10/811,459

(22) Filed: Mar. 26, 2004

Related U.S. Application Data
(60) Provisional application No. 60/457,780, filed on Mar. 26, 2003.

(51) Int. Cl. G06F 17/60

(52) U.S. Cl. 705/38

(57) ABSTRACT

A system for facilitating residential home mortgage transactions comprises a workflow management module and a collaborative transaction management module. The workflow management module is configured for implementing workflow management of residential home mortgage transaction tasks dependent upon at least one of workflow states of the residential home mortgage transaction tasks and prescribed workflow management rules. The collaborative transaction management module is coupled to the workflow management module for enabling interaction between the modules and is configured for implementing access to system-managed workflow information by designated transaction parties dependent upon at least one of the workflow states of the residential home mortgage transaction tasks, the prescribed workflow management rules and prescribed collaborative transaction management rules.

### CROSS REFERENCE TO RELATED APPLICATIONS

This application claims priority to co-pending United States Provisional Patent Application having Ser. No. 60/457,780 filed Mar. 26, 2003 entitled “Workflow automation and customer relationship management system and method for the origination, processing, closing and funding of loans”, having a common applicant herewith.

### FIELD OF THE DISCLOSURE

The disclosures made herein relate generally to computer-implemented methods and systems for making residential home mortgages and, more particularly, to facilitating automated workflow and collaborative transaction management for making residential home mortgages.

### BACKGROUND

Workflow for residential home mortgage transactions (i.e., transactions required for making a residential home mortgage) is typically carried out through a manual ad-hoc approach that is paper-based and time-intensive. Examples of such residential home mortgage transactions include transactions associated with residential home mortgage origination, processing, closing and funding. This approach results in frequent error and unnecessary delay. Furthermore, this approach generally results in broken, if any, communication and fails to share residential home mortgage application status (e.g., approval information) between the parties to the residential home mortgage transactions. As a result of the broken communication and failure to share mortgage application status information, many parties involved in the residential home mortgage transactions find the experience frustrating, inefficient and/or unprofessional. Examples of the parties involved in such residential home mortgage transactions include a buyer (e.g., the borrower), a selling real estate agent, a listing real estate agent, a mortgage originator, a mortgage processor, an appraiser, a surveyor, a title/escrow agent and a homeowner's insurance agent.

The most common conventional method of tracking the progress of the status tasks in a residential home mortgage transaction that is used by traditional residential home mortgage brokers is the use of a paper checklist. The paper checklist is customarily attached to the inside front cover of a folder containing the pertinent residential home mortgage documents. The intent of this method is for various personnel at the mortgage brokerage company to check items on the checklist as they are completed (e.g., prepared, ordered, received, etc). However, this approach depends heavily on the ability of these various personnel to peruse each and every file daily to ensure the application progresses toward a funding event (e.g., closing). Because this approach is prone to human error and forgetfulness, this approach does not adequately ensure expedient and proactive mortgage application administration. The residential home mortgage brokerages of few companies address the need to deliver meaningful, frequent application status to other participants in the transaction. For example, the realtors and the buyer involved in a residential home mortgage transaction typically must call the mortgage company repeatedly to ascertain the current status of the residential home mortgage application and determine whether their mortgage transaction is progressing toward closing.

Various computer-implemented loan origination systems are known. However, such computer-implemented loan origination systems exhibit one or more limitations, particularly in view of requirements of residential home mortgages, which adversely affect their usefulness. Examples of such limitations include, but are not limited to, lacking automated workflow functionality with internal and external parties in a transaction, being designed for tasks of only select parties in loan transactions, being ill-suited to the current format of brokerage operations, not satisfactorily addressing a full array of key user needs, being out-dated to the point where current technology is not taken advantage of, being designed primarily for generating forms, offering little-to-no system networking capability, providing limited interaction capability with service provider systems/software, and not being scalable beyond a single user.

Therefore, facilitating workflow and management of residential home mortgage transactions in a manner that overcomes limitations associated with conventional approaches for facilitating workflow and management of loan transactions would be useful and novel.

### SUMMARY OF THE DISCLOSURE

Embodiments of the inventive disclosures made herein are comprised by methods and/or equipment configured for facilitating workflow automation and collaborative transaction management in making residential home mortgages. Such embodiments of the inventive disclosures enable professionals involved in facilitating residential home mortgage transactions to increase productivity, reduce liability, enhance professionalism, maintaining client relations and/or assist in generating business prospects.

In one embodiment, a system for facilitating residential home mortgage transactions comprises a workflow management module and a collaborative transaction management module. The workflow management module is configured for implementing workflow management of residential home mortgage transaction tasks dependent upon at least one of workflow states of the residential home mortgage transaction tasks and prescribed workflow management rules. The collaborative transaction management module is coupled to the workflow management module for enabling interaction between the modules and is configured for implementing access to system-managed workflow information by designated transaction parties dependent upon at least one of the workflow states of the residential home mortgage transaction tasks, the prescribed workflow management rules and prescribed collaborative transaction management rules.

In another embodiment, a computer-implemented method for facilitating residential home mortgage transactions comprising implementing workflow management of residential home mortgage transaction tasks and implementing access to system-managed workflow information by designated transaction parties. Implementing the residential home mortgage transaction tasks is performed dependent upon at least one of workflow states of the residential home mortgage transaction tasks and prescribed workflow management rules. Implementing access to system-managed workflow information is performed dependent upon at least one of the workflow states of the residential home mortgage transaction tasks, the prescribed workflow management rules and prescribed collaborative transaction management rules.

Accordingly, it is a principal object of the inventive disclosures made herein to provide methods and equipment that enable residential home mortgage transactions to be performed in a manner that is less time-consuming, more predictable and more professional.

It is another object of the inventive disclosures made herein to provide workflow automation that establishes consistent and predictable business processes in facilitating residential home mortgage transactions.

It is another object of the inventive disclosures made herein to provide workflow automation that standardizes and streamlines business processes in facilitating residential home mortgage transactions.

It is another object of the inventive disclosures made herein to automate the creation, scheduling, tracking and execution of workflow tasks associated with originating, processing, closing and/or funding residential home mortgages.

It is another object of the inventive disclosures made herein to provide for collaborative transaction management for internal (i.e., within a mortgage company) and external parties of a residential home mortgage transaction.

It is another object of the inventive disclosures made herein to provide for access to documentation and status information by internal transaction parties (e.g., mortgage company personnel) and external transaction parties (e.g., service providers, real estate agents, mortgage applicant, etc).

It is another object of the inventive disclosures made herein to provide a single source of workflow information (e.g., a single database) for enabling facilitation of such workflow automation and collaborative transaction management.

It is another object of the inventive disclosures made herein to provide a systematic approach for strengthening client relationships in a residential home mortgage transaction.

It is another object of the inventive disclosures made herein to provide a residential home mortgage document with a barcode that designates a unique identity of the residential home mortgage document and to scan the barcode for determining an identity of the document in response to receiving a copy of the residential home mortgage document.

These and other objects of the inventive disclosures made herein will become readily apparent upon further review of the following specification and associated drawings.

### BRIEF DESCRIPTION OF THE DRAWINGS

FIG. 1 depicts a high-level view of a schematic for facilitating automated and collaborative transaction management functionalities in accordance with an embodiment of the inventive disclosures made herein.

FIG. 2 depicts a network-based system configured for facilitating automated workflow and collaborative transaction management functionalities in accordance with an embodiment of the inventive disclosures made herein.

FIGS. 3A through 3D depict a method for facilitating automated workflow and collaborative transaction management functionalities in accordance with an embodiment of the inventive disclosures made herein.

FIGS. 4A through 4E depict aspects of a network-based collaborative transaction management arrangement configured for supporting automated workflow management functionality in accordance with an embodiment of the inventive disclosures made herein.

### DETAILED DESCRIPTION OF THE DRAWINGS

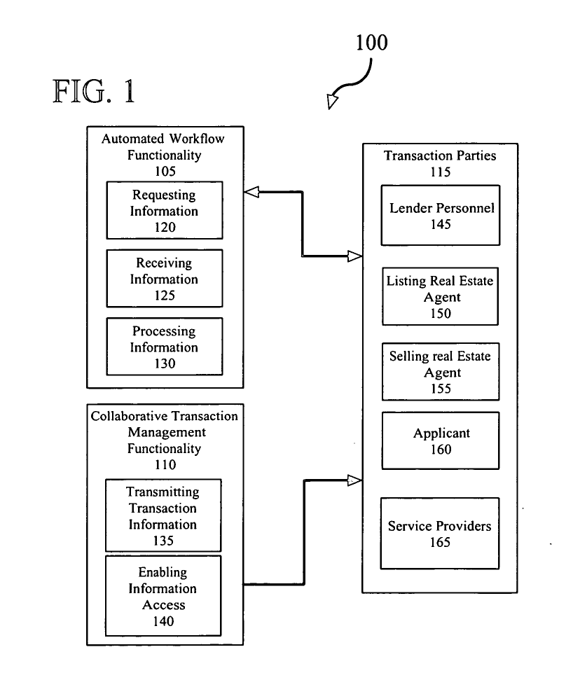

FIG. 1 depicts a high-level view of a schematic 100 configured for facilitating workflow automation and collaborative transaction management in accordance with an embodiment of the inventive disclosures made herein. The schematic 100 includes workflow automation functionality 105 and collaborative transaction management functionality 110. As discussed in greater detail below, the workflow automation functionality 105 and the collaborative transaction management functionality 110 facilitate the transmittal of information to and receipt of information from all or a portion of transaction parties 115 for systematically and predictably carrying out residential home mortgage transactions in a manner whereby the transaction parties enjoy increased productivity, reduced liability, enhanced professionalism, improved client relations and/or enhanced generation of business prospects.

The automated workflow functionality 105 includes functionality 120 for requesting information, functionality 125 for receiving such information and functionality 130 for processing such information. The collaborative transaction management functionality 110 includes functionality 135 for transmitting transaction information to all or a portion of the transaction parties 115 and functionality 140 for enabling access to such transaction information by all or a portion of the transaction parties 115. Lender personnel 145 (e.g., mortgage administrators such as mortgage officers, mortgage processors, etc), a listing real estate agent 150, a selling real estate agent 155, an applicant 160 (i.e., the home buyer) and service providers 165 (e.g., title company, appraiser, surveyor, closing attorney, investor, tax certification professional, flood certification professional, insurance agent, etc.) are examples of the service providers 165. Such mortgage officers and mortgage processors are often referred to as loan officers and loan processors. Furthermore, within the scope of residential home mortgages, the term loan is often used synonymously with mortgage in some contexts.

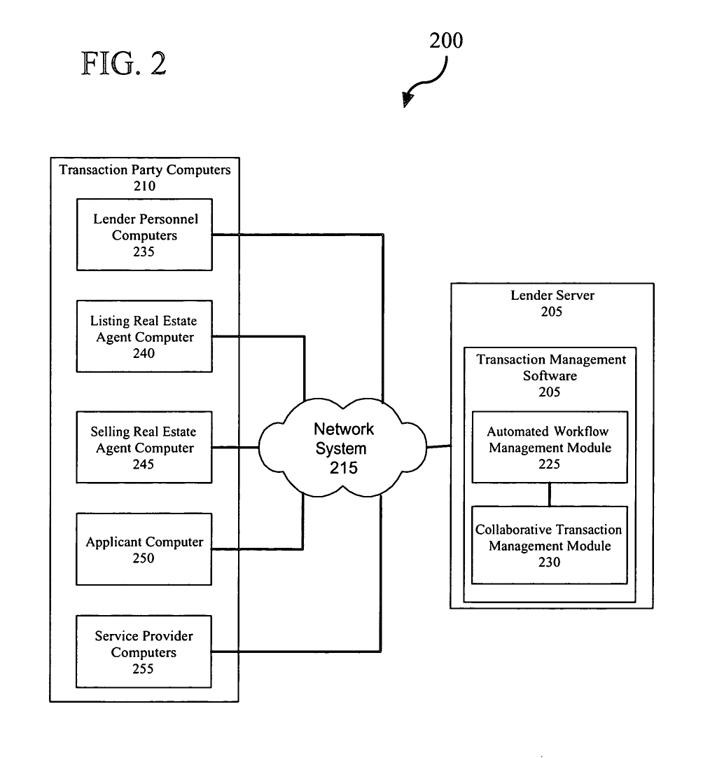

FIG. 2 depicts a network-based system 200 configured for facilitating automated workflow and transaction management functionalities in accordance with an embodiment of the inventive disclosures made herein. The network-based system 200 includes a lender server 205 (e.g., a commercially-available server), a plurality of transaction party computers 210 (e.g., commercially-available personal computers) and a network system 215 (e.g., the Internet and one or more local area networks connected to the Internet). The lender server 205 (i.e., the server of a lender company) and the plurality of transaction party computers 210 are coupled to the network system 215 for enabling interaction therebetween.

The lender server 205 has transaction management software 220 running thereon that is configured for carrying out automated workflow and collaborative transaction management functionalities in accordance with an embodiment of the inventive disclosures made herein. In one embodiment (i.e., as depicted), the transaction management software 220 includes a workflow management module 225 and a collaborative transaction management module 230 coupled to the workflow management module 225, thereby enabling interaction therebetween. The workflow management module 225 is configured for implementing workflow management functionality as discussed above in reference to FIG. 1 and as discussed below in greater detail. The collaborative transaction management module 230 is configured for implementing access functionality (e.g., accessing residential home mortgage transaction information over the Internet via a web browser) as discussed above in reference to FIG. 1 and as discussed below in greater detail.

Although not specifically shown, the lender server 205 is a commercially-available server that includes typical components such as random access memory from which instructions comprised by the transaction management software 220, one or more data processors capable of interpreting and implementing such instructions, a network interface device for enabling interaction via the network system 215 and non-volatile storage for storing transaction management information. Lender personnel computers 235 (i.e., computers utilized by personnel of the lender company), a listing agent computer 240 (i.e., a computer utilized by a listing real-estate agent), a selling real-estate computer 245 (i.e., a computer utilized by a selling real-estate agent), an applicant computer 250 (i.e., a computer utilized by a mortgage applicant) and service provider computers 255 (i.e., computers utilized by personnel of service provider companies) are examples of the transaction party computers 210, which may be commercially-available desktop computer systems.

In one embodiment, systems and methods in accordance with the inventive disclosures made herein are implemented via web-based functionality (e.g., network-based applications) that provide access via web-browsers to information and operational functionality served from a server. In another embodiment, systems and methods in accordance with the inventive disclosures made herein are implemented via client-server functionality that provides primary operating functionality via an application running on a client system and information aggregation/access via a server connected to the client system.

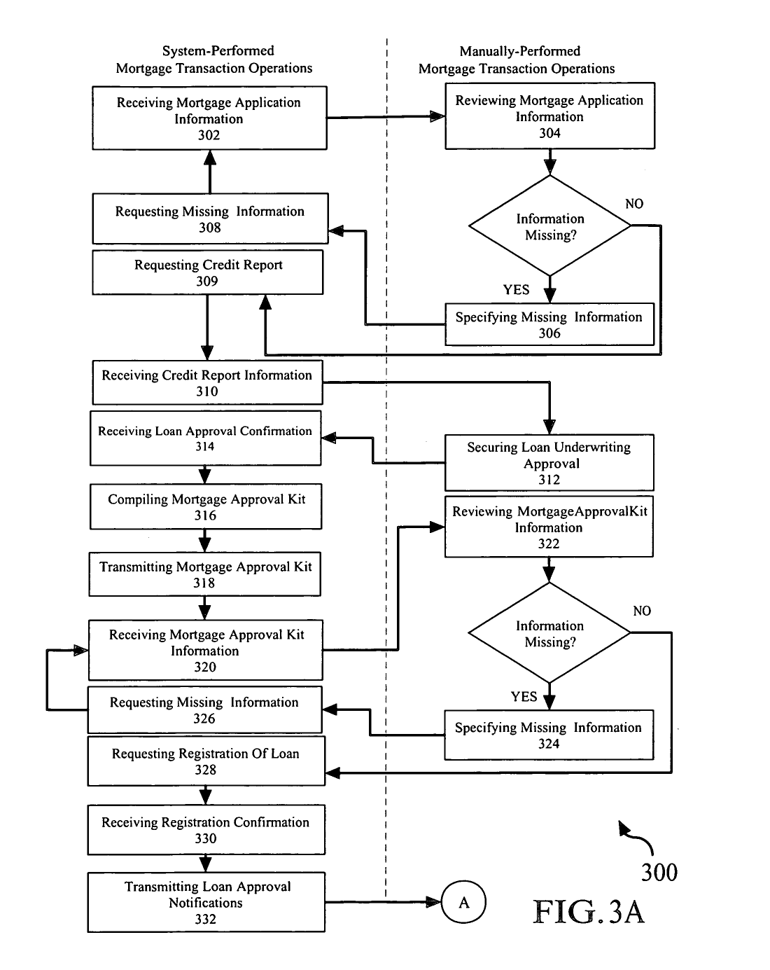

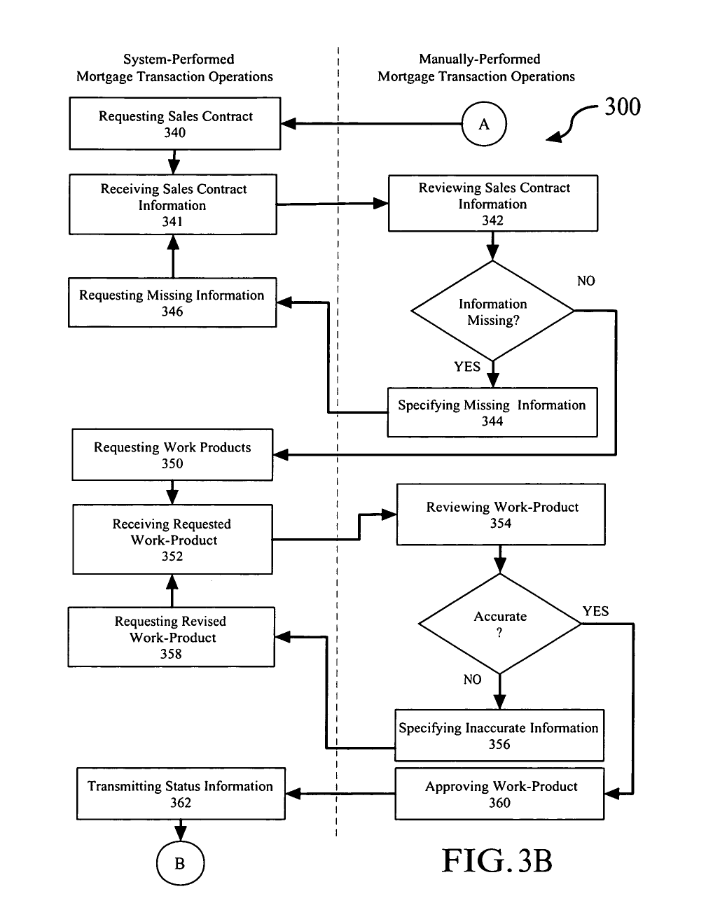

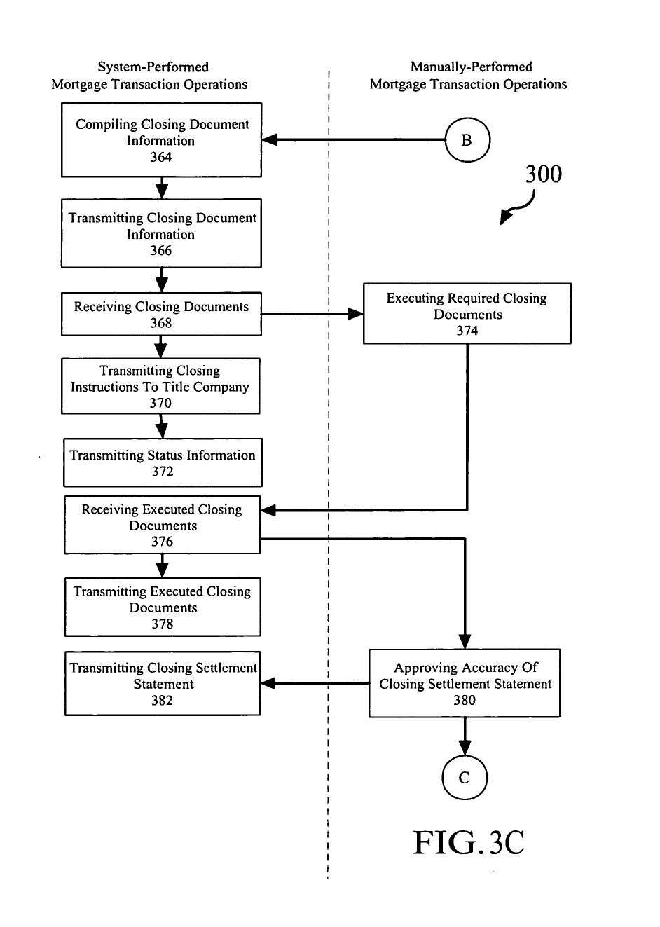

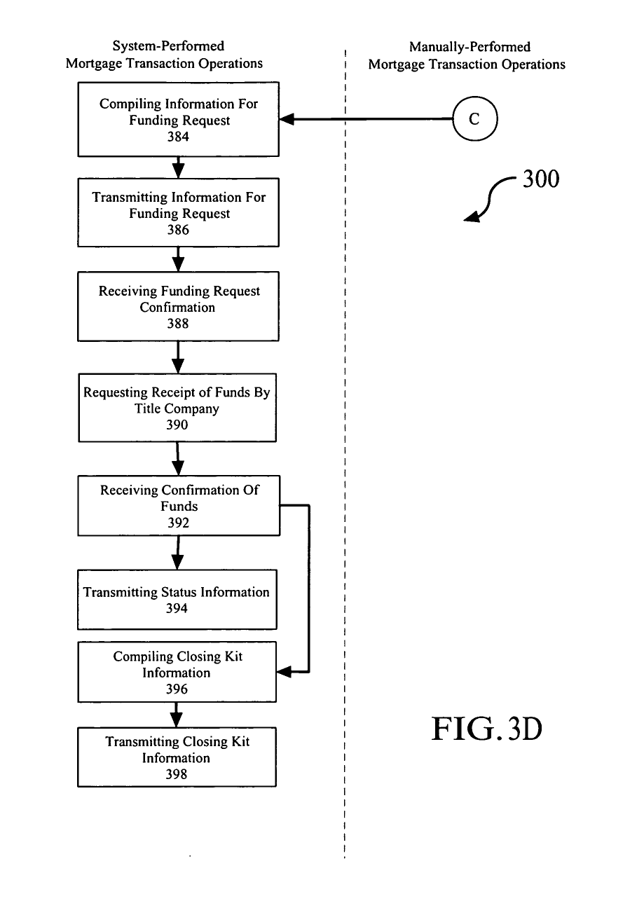

FIGS. 3A through 3D depict a method 300 for facilitating automated workflow and collaborative transaction management functionalities in accordance with an embodiment of the inventive disclosures made herein. As depicted, the method 300 includes system-performed mortgage transaction operations and manually-performed mortgage transaction operations. These operations individually and/or jointly correspond to residential home mortgage transaction tasks, which include tasks required for originating, processing, closing and/or funding a residential home mortgage. Advantageously and novelly, the system-performed mortgage transaction operations provide for a systematic, computer-implemented approach to facilitating workflow and transaction management functionalities. Unlike conventional approaches for facilitating workflow and/or transaction management (e.g., manual, paper-based approaches), the method 300 and systems configured for carrying out the method 300 actively seeks to ensure completion of the manually-performed mortgage transaction operations whereby progression of residential home mortgage transactions are not dramatically hindered by delays in performing such manually-performed mortgage transaction operations. Also unlike such conventional approaches for facilitating workflow and/or transaction management, the method 300 and systems configured for carrying out the method 300 are advantageously and novelly facilitated dependent upon interaction with transaction parties internal to a mortgage company (e.g., a mortgage processor, a mortgage officer, etc) and transaction parties external to the mortgage company (e.g., service providers, the applicant, the listing and/or selling real estate agents, etc).

Referring to FIG. 3A, which generally depicts operations associated with originating a residential home mortgage, an operation 302 is performed for receiving mortgage application information. It is contemplated and disclosed herein that the mortgage application information is received by any number of approaches. One embodiment of receiving the mortgage application information is to provide an on-line form for enabling an applicant to provide such information to be provided electronically directly from the applicant via the on-line form (e.g., accessible via a web browser). Another embodiment of receiving the mortgage application information is for mortgage company personnel to transcribe the mortgage application information into corresponding system-provided fields from a written/typed information source (e.g., manually completed mortgage application/scanned/faxed) or audible information source (e.g., a conversation with the applicant).

After the mortgage application information is received, an operation 304 is performed for reviewing the mortgage application information for completeness. For example, a first person such as a mortgage officer may enter the mortgage application information and a second person such as a mortgage processor may review the mortgage application information. In response to determining that required mortgage application information is missing (e.g., not provided or incorrectly provided), an operation 306 is performed for specifying the missing mortgage application information. In one embodiment, specifying the missing mortgage application information includes specifying the missing mortgage application information on a system-maintained list of required mortgage application information. For example, a mortgage processor designates received mortgage application information by checking corresponding boxes displayed by the transaction management software referred to in FIG. 2. After specifying the missing mortgage application information, an operation 308 is performed for requesting the missing mortgage application information. In one embodiment, requesting the missing mortgage application information includes transmitting an initial request to an e-mail account, computer and/or fax machine of the applicant and, as required, transmitting subsequent reminder notices and/or overdue notices in response to certain workflow management rules being satisfied (e.g., not receiving such information within specified periods of time).

In response to all of the required mortgage application information being received, an operation 309 is performed for requesting (e.g., ordering) a credit report for the applicant (including any joint applicant or applicants). In one embodiment, requesting the credit report includes transmitting an initial request to a corresponding service provider processing system, e-mail account and/or fax machine, and transmitting subsequent reminder notices and/or overdue notices as required. The operation 309 for requesting the credit report is performed automatically in response to one or more workflow management rules being satisfied. Examples of such workflow management rules include all of the required mortgage application information having been received and any applicable fees (e.g., mortgage origination fees) having been paid.

After requesting the credit report, an operation 310 is performed for receiving the credit report information. One embodiment of receiving the credit report information is to receive credit report information electronically from the service provider (e.g., imported/uploaded from the service provider computer system, via an e-fax from the service provider computer system, etc), followed by a designation being made (e.g., manually checking a box) that such information has been received. Another embodiment of receiving the credit report information is for mortgage company personnel to transcribe the credit report information from a printed information source (e.g., printed copy of the credit report) into corresponding system-provided fields.

In response to receiving the credit report information, an operation 312 is performed for securing loan underwriting approval. In one embodiment (i.e., as disclosed), securing loan underwriting approval is performed via a discrete or interfaced system. In another embodiment, integral system functionality is provided for performing the operation 312 for securing loan underwriting approval. For example, a system-performed mortgage transaction operation is performed dependent upon one or more workflow management rules. Examples of such workflow management rules include all required credit report information having been received.

After an operation 314 is performed for receiving confirmation of loan underwriting approval, an operation 316 is performed for compiling a mortgage approval and disclosure kit (e.g., preparing documents/information comprised by the mortgage approval and disclosure kit), followed by an operation 318 being performed for transmitting the mortgage approval and disclosure kit for reception by a computer system, e-mail account and/or fax machine of the mortgage applicant. Examples of documents comprised by the mortgage approval and disclosure kit include a copy of the mortgage application, a good faith estimate, a truth-in-lending statement, and other documents that are typically required for proceeding with processing of a mortgage application. The operation 316 for compiling the mortgage approval and disclosure kit and the operation 318 for transmitting the mortgage approval and disclosure kit are performed automatically in response to one or more workflow management rules being satisfied. Examples of such workflow management rules include having received confirmation of the loan underwriting approval.

After transmitting the mortgage approval and disclosure kit, an operation 320 is performed for receiving mortgage approval and disclosure kit information from the applicant. One embodiment of receiving the mortgage approval and disclosure kit information is for mortgage company personnel to manually receive the approval kit information and designate reception of such received information (e.g., by checking corresponding boxes displayed by the transaction management software referred to in FIG. 2). Another embodiment of receiving the mortgage approval and disclosure kit information is to receive the mortgage approval and disclosure kit information electronically from the mortgage applicant (e.g., imported/uploaded from the mortgage applicant computer system, via an e-fax from the mortgage applicant, etc).

After the mortgage application information is received, an operation 322 is performed for reviewing the mortgage approval and disclosure kit information for completeness. In response to determining that required mortgage approval and disclosure kit information is missing (e.g., not provided or incorrectly provided), an operation 324 is performed for specifying the missing mortgage approval and disclosure kit information. In one embodiment, specifying the missing mortgage approval and disclosure kit information includes specifying the missing mortgage approval and disclosure kit information on a system-maintained list of required mortgage approval and disclosure kit information. For example, a mortgage processor designates received mortgage approval and disclosure kit information by checking corresponding boxes displayed by the transaction management software referred to in FIG. 2. After specifying the missing mortgage approval and disclosure kit information, an operation 326 is performed for requesting the missing mortgage approval and disclosure kit information. In one embodiment, requesting the missing mortgage approval and disclosure kit information includes transmitting an initial request for reception by an e-mail account, computer and/or fax machine of the applicant and, as required, transmitting subsequent reminder notices and/or overdue notices in response to certain workflow management rules being satisfied (e.g., not receiving such information within specified periods of time).

In response to all of the required mortgage approval and disclosure kit information being received, an operation 328 is performed for requesting registration of the loan with a designated wholesale investor. In one embodiment, requesting registration of the loan includes transmitting an initial request for reception by an e-mail account, computer and/or fax machine of the investor and, as required, transmitting subsequent reminder notices and/or overdue notices in response to certain workflow management rules being satisfied (e.g., not receiving such information within specified periods of time). The operation 328 for requesting registration of the loan is performed automatically in response to one or more workflow management rules being satisfied. Examples of such workflow management rules include all required mortgage approval and disclosure kit information having been received.

After requesting registering of the loan with the designated wholesale investor, an operation 330 is performed for receiving loan registration confirmation. An operation 332 is performed for transmitting a loan approval notification for reception by, for example, an e-mail account, computer and/or fax machine of designated mortgage transaction parties (e.g., the applicant, selling real estate agent and listing real estate agent) in response to receiving the loan registration confirmation. Information (e.g., an access link, a passcode and user name) for enabling access of mortgage transaction information via a network (e.g., the Internet) is an example of information included in the loan approval notification. The operation 332 for transmitting the loan approval notifications is performed automatically in response to one or more workflow management rules being satisfied. Examples of such workflow management rules include the registration confirmation having been received.

Referring to FIG. 3B, which generally depicts operations associated with processing and closing a mortgage, an operation 340 for requesting sales contract information is performed. In one embodiment, requesting the sales contract information includes transmitting an initial request for reception by, for example, an e-mail account, computer and/or fax machine of the appropriate transaction party (e.g., the selling real estate agent) and, as required, transmitting subsequent reminder notices and/or overdue notices in response to certain workflow management rules being satisfied (e.g., not receiving such information within specified periods of time). It is contemplated that requesting the sales contract information is performed in response to one or more transaction management rules being satisfied. Securing loan underwriting approval is an example of such transaction management rules. It is contemplated and disclosed herein that the sales contract information may be requested at a different timeframe in the method 300 (e.g., at an earlier timeframe than depicted, such as when the loan approval notifications are transmitted).

An operation 341 is performed for receiving the sales contract information after requesting such information. It is contemplated and disclosed herein that sales contract information is received by any number of approaches. One embodiment of receiving the sales contract information is to provide an on-line form for enabling an applicant to provide such information to be provided electronically directly from the applicant via the on-line form (e.g., accessible via a web browser). Another embodiment of receiving the sales contract information is for mortgage company personnel to transcribe the sales contract information into corresponding system-provided fields from a written/typed information source (e.g., manually completed sales contract documents).

After receiving the sales contract information, an operation 342 is performed for reviewing the sales contract information. In response to determining that required sales contract information is missing (e.g., not provided or incorrectly provided), an operation 344 is performed for specifying the missing sales contract information. In one embodiment, specifying the missing sales contract information includes specifying the missing sales contract information on a system-maintained list of required sales contract information. For example, a mortgage processor designates received sales contract information by checking corresponding boxes displayed by the transaction management software referred to in FIG. 2. After specifying the missing sales contract information, an operation 346 is performed for requesting the missing sales contract information. In one embodiment, requesting the missing sales contract information includes transmitting an initial request for reception by, for example, an e-mail account, computer or fax machine of the applicant and, as required, transmitting subsequent reminder notices and/or overdue notices in response to certain workflow management rules being satisfied (e.g., not receiving such information within specified periods of time).

In response to all of the required sales contract information being received, a sequence of operations 350 is performed for requesting service provider work-products. Wiring instructions, insured closing letter, title commitment, tax certification, appraisal, flood certification, survey and hazard insurance binder are examples of service provider work-products. In one embodiment, requesting the service provider work-products includes transmitting an initial request for reception by respective service provider computer systems, fax machines and/or e-mail accounts and, as required, transmitting subsequent reminder notices and/or overdue notices in response to certain workflow management rules being satisfied (e.g., not receiving such information within specified periods of time). All required sales contract information being received is an example of a workflow management rule that must be satisfied prior to requesting the service provider work products.

After requesting the service provider work-products, a sequence of operations 352 is performed for receiving the service provider work-products, followed by an operation 354 being performed for reviewing the service provider work-products for accuracy. In one embodiment, receiving the work product information is facilitated via system-managed service provider workspaces (e.g., work spaces provided via the transaction management software referred to in FIG. 2). In this embodiment, transaction parties (e.g., service providers, applicants, real estate agents, etc) are provided access to system-managed (e.g., web-based) workspaces containing listing of various order types (e.g., new, pending, complete, cancelled/withdrawn) and configured for enabling work-product information, as well as other information, to be inputted, maintained, and managed. Another embodiment of receiving work-product information is for mortgage company personnel to transcribe the work-product information into corresponding system-provided fields from a written/typed information source (e.g., manually completed sales contract documents). Still another embodiment of receiving work-product information is receiving such work-product information electronically from a service provider managed system (e.g., an on-line system) configured for enabling service requesters (e.g., mortgage companies) to request and receive offered work-product information over a network (e.g., the Internet).

In response to determining that a particular one of the service provider work-products is inaccurate (e.g., missing information or including inaccurate information), an operation 356 is performed for specifying the inaccurate work-product information. In one embodiment, specifying the inaccurate work-product information includes specifying the inaccurate information on a system-maintained form. After specifying the inaccurate work-product information, an operation 358 is performed for requesting a respective revised work-product. In one embodiment, requesting the respective revised work-product includes transmitting an initial request for reception by, for example, a computer system, an e-mail account and/or a fax machine of the service provider and, as required, transmitting subsequent reminder notices and/or overdue notices in response to certain workflow management rules being satisfied (e.g., not receiving the revised work-product within specified periods of time).

In response to each accurately-prepared work-products being received, an operation 360 is performed for approving each work-products and an operation 362 is performed for transmitting status information (e.g., work-product receipt notifications) for reception by, for example, an e-mail account and/or fax machine of the appropriate transaction parties (e.g., the selling real estate agent and the applicant). In one embodiment, approving each work-product includes designating approval of a particular work-product on a system-maintained list of required work-products. For example, a mortgage processor designates approved work-products by checking corresponding boxes displayed by the transaction management software referred to in FIG. 2.

Referring to FIG. 3C, which generally depicts operations associated with processing and closing a mortgage, an operation 364 is performed for compiling closing document information for being submitted to support preparation of closing documents. Examples of such closing document information include all or a portion of work-product information discussed above, a closing document worksheet summarizing the required closing documents, and other information/documents. The operation 364 for compiling closing document information is performed automatically in response to one or more workflow management rules being satisfied. Examples of such workflow management rules include each of the work-products being reviewed and finally approved for accuracy.

An operation 366 is performed for transmitting the compiled closing document information for reception by, for example, a computer, e-mail account and/or fax machine of the lender's closing department (e.g., of a designated person in the closing department) in response to the closing document information being compiled. It is contemplated and disclosed herein that compiling the closing document information may be performed integrally with the operation 366 for transmitting the closing document information.

After transmitting the closing document information, an operation 368 is performed for receiving the closing documents. In one embodiment, the closing documents are received through a means such as being faxed, scanned or uploaded (e.g., after a digital signature is applied), followed by a designation being made (e.g., in a system-managed checklist) that such documents have been received. In response to receiving the closing documents, an operation 370 is performed for transmitting system-defined closing instructions for reception by an e-mail account, fax machine and/or computer system of a designated title company and an operation 372 is performed for transmitting status information (e.g., notification that the title company is in receipt of the closing documents) for reception by fax machines, computers and/or e-mail accounts appropriate designated transaction parties (e.g., the selling real estate agent and the applicant).

After the closing documents are received and after an authorized representative of the mortgage company performs an operation 374 for executing the closing documents (e.g., applying a digital signature or printing and applying a manual signature), an operation 376 is performed for receiving the executed closing documents. In one embodiment, the closing documents are received through a means such as being faxed, scanned or uploaded (e.g., after a digital signature is applied), followed by a designation being made that such documents have been received. In response to the executed closing documents being received, an operation 378 is performed for transmitting the executed closing documents for reception by e-mail address, a computer system and/or fax machine of the title company.

After an operation 380 is performed for approving accuracy of the closing settlement statement (i.e., one of the closing documents), an operation 382 is performed for transmitting a copy of the approved closing settlement statement and closing instructions for reception by, for example, a computer, e-mail account and/or fax machine of the applicant. To comply with federal and/or state laws, the settlement statement is preferably and advantageously submitted to the applicant at least 24 hours before a designated closing time.

Referring to FIG. 3D, which generally depicts operations associated with closing and funding a mortgage, an operation 384 is performed for compiling information required for a funding request. Examples of such information include a final underwriting clear of any conditions, completed closing worksheet, mortgage note, insured closing letter, hazard insurance binder, flood certificate, initial escrow amount disclosure, wiring instructions, mortgage insurance certificate and other required documents. The operation 384 for compiling such information is performed automatically in response to one or more workflow management rules being satisfied. Examples of such workflow management rules include designation e.g., by a mortgage officer or processor that the mortgage has been closed. For example, a mortgage processor designates closing of the mortgage by checking an appropriate box displayed by the transaction management software referred to in FIG. 2.

In response to compiling the information required for the funding request, an operation 386 is performed for transmitting the information for reception by, for example, a computer, e-mail account and/or fax machine of the wholesale investor. It is contemplated and disclosed herein that compiling the information required for the funding request may be performed integrally with transmitting the information required for the funding request.

After transmitting the information required for the funding request and in response to performing an operation 388 for receiving a funding request confirmation from the wholesale investor, an operation 390 is performed for requesting a receipt of funds from the title company. It is contemplated herein that requesting the receipt of funds also includes a request for proceeds and a request for verification of mortgage being closed and funded. Thereafter, an operation 392 is performed for receiving the receipt of funds from the title company and confirmation that the mortgage is funded and closed. In one embodiment, the receipt of funds from the title company and confirmation that the mortgage is funded and closed are received through a means such as being faxed, scanned or uploaded (e.g., after a digital signature is applied) followed by a corresponding designation (e.g., by the mortgage processor or officer) being made (e.g., checking a box) that this information has been received.

In response to receiving the receipt of funds from the title company and confirmation that the mortgage is funded and closed, an operation 394 is performed for transmitting status information (e.g., status of closing/funding and thank you notice) to appropriate transaction parties (e.g., the selling realtor, the listing realtor and/or the applicant) and an operation 396 is performed for compiling closing kit information for the mortgage. In response to compiling the closing kit information, an operation 398 is performed for transmitting the closing kit information for reception by, for example, a computer, e-mail account and/or fax machine of the lender's accounting department (e.g., of a designated person in the accounting department)

As disclosed herein, it is contemplated and disclosed that documents may be received and transmitted over a network. A document format such as ABODE SYSTEM Portable Document Format (i.e., .pdf files) is a preferred file format for enabling such transmission of documents. Such a document format allows for documents to be conveniently shared between computer systems.

A novel and advantageous embodiment of the inventive disclosures made herein is bar-coding of system-generated and externally generated documents. Bar-coding of such documents advantageously and novelly allows for such documents to be tracked and inputted in a manner that saves time, reduces logistical issues and generally provides for document management without human intervention. In one embodiment, a unique barcode is provided on system-generated documents and barcode information that uniquely corresponds to information associated with each document is stored (e.g., in a database). Thereafter, when a bar-coded document is scanned back into the system (e.g., after being printed out and executed), the bar-coded document is readily identifiable via scanning apparatus of a system as disclosed herein (e.g., the system 200 depicted in FIG. 2). To this end, it is contemplated and disclosed herein that, in one embodiment, the system 200 includes hardware for facilitating scanning of the barcodes on documents (e.g., a document scanner), instructions configured for enabling information corresponding to a barcode determined in response to scanning the bar-coded, instructions configured for enabling barcodes to be assigned to documents and memory space for storing barcode-related information.

For example, when an order or request is generated for an applicant to sign and return contents of the mortgage approval and disclosure kit, a system in accordance with the inventive disclosures made herein generates barcodes on the documents so the applicant simply faxes the signed documents back into system and the system would route the electronic representation of the documents to appropriate placeholders dependent on the barcode information. Some barcodes relate to order forms so a work-product service provider can fax the completed work-product back with the bar-coded order form as a cover sheet for enabling system-automated routing of the document to appropriate mortgage and placeholder within the system.

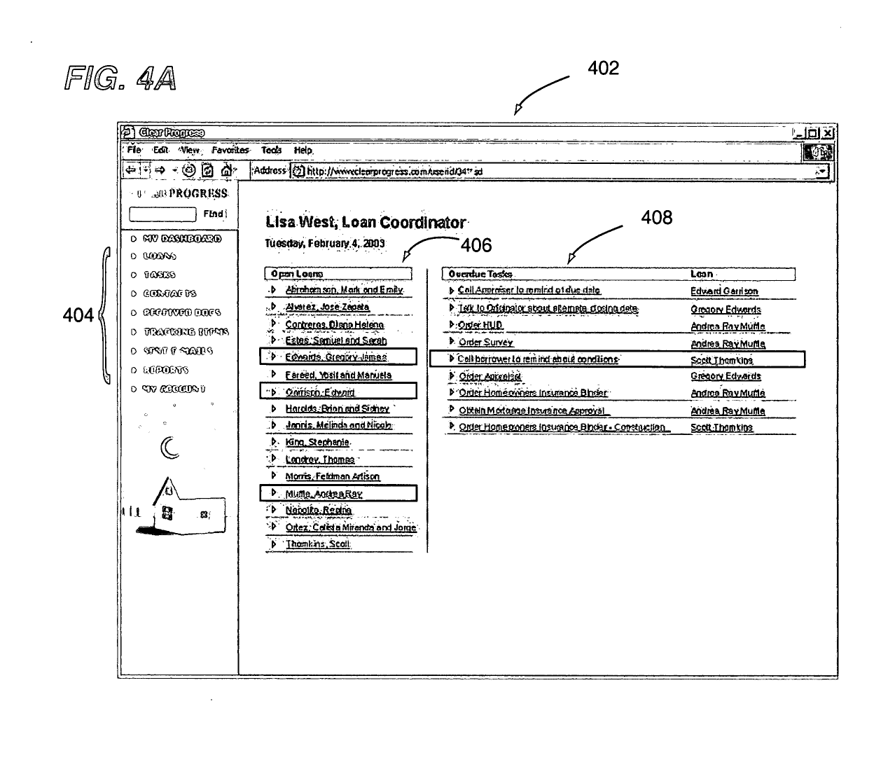

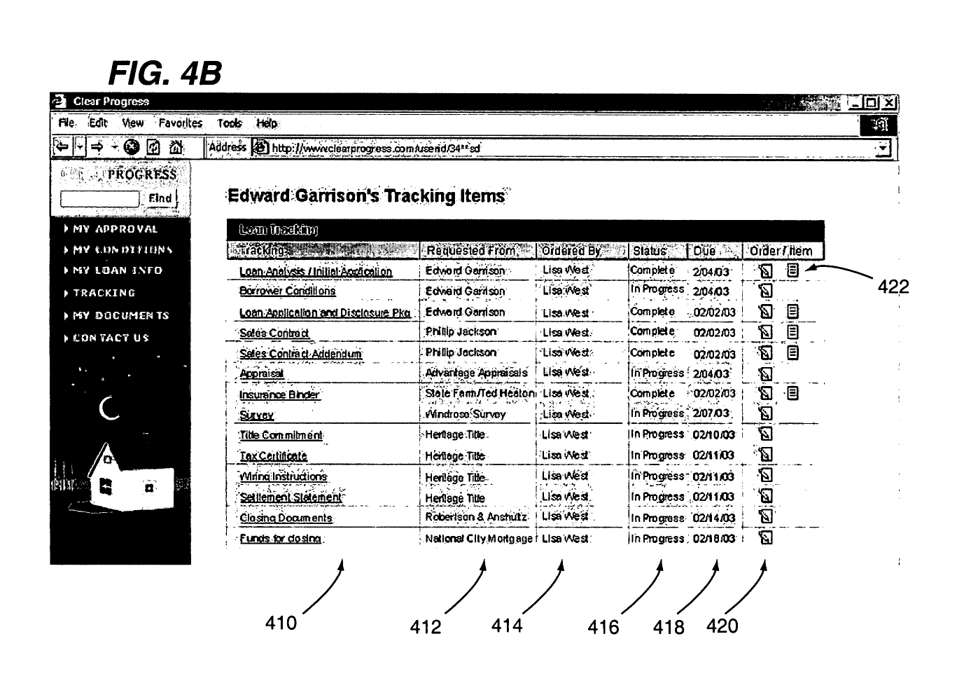

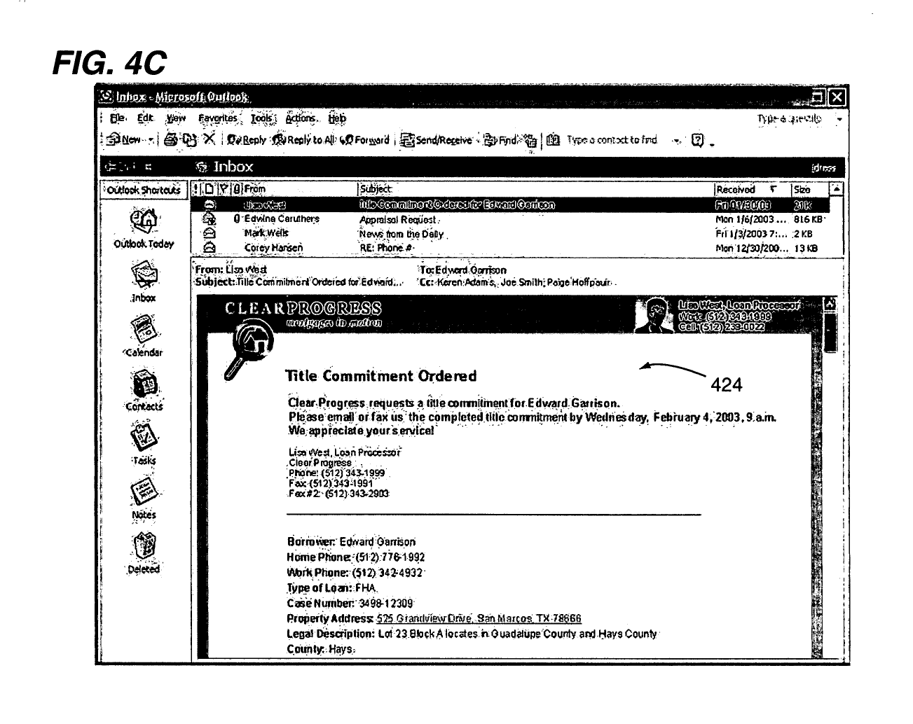

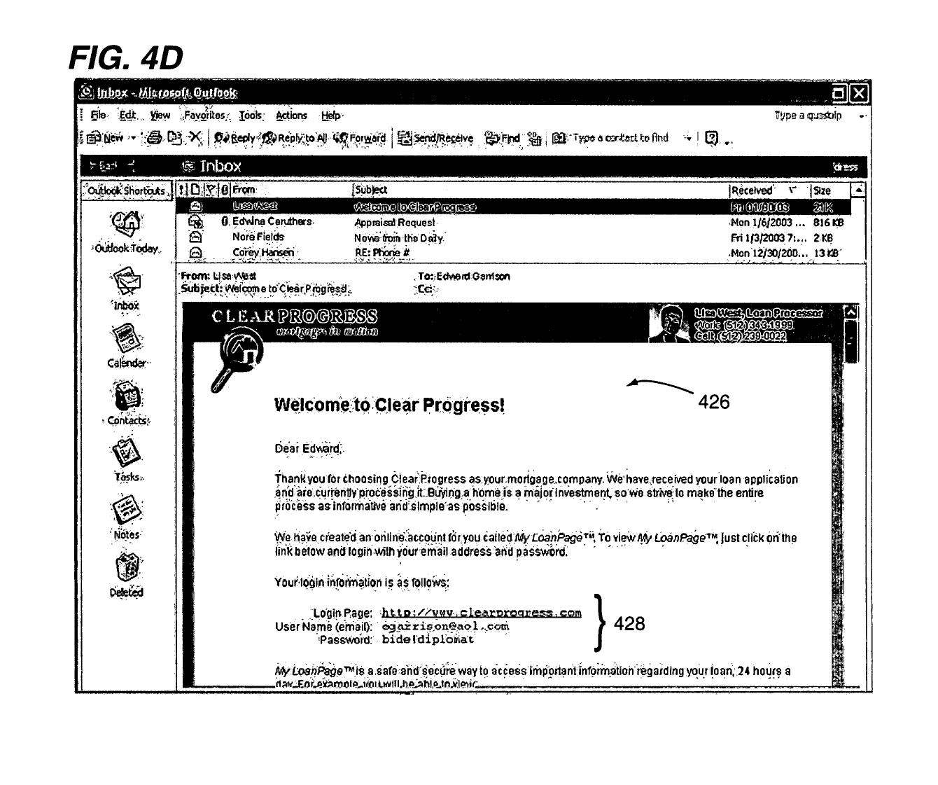

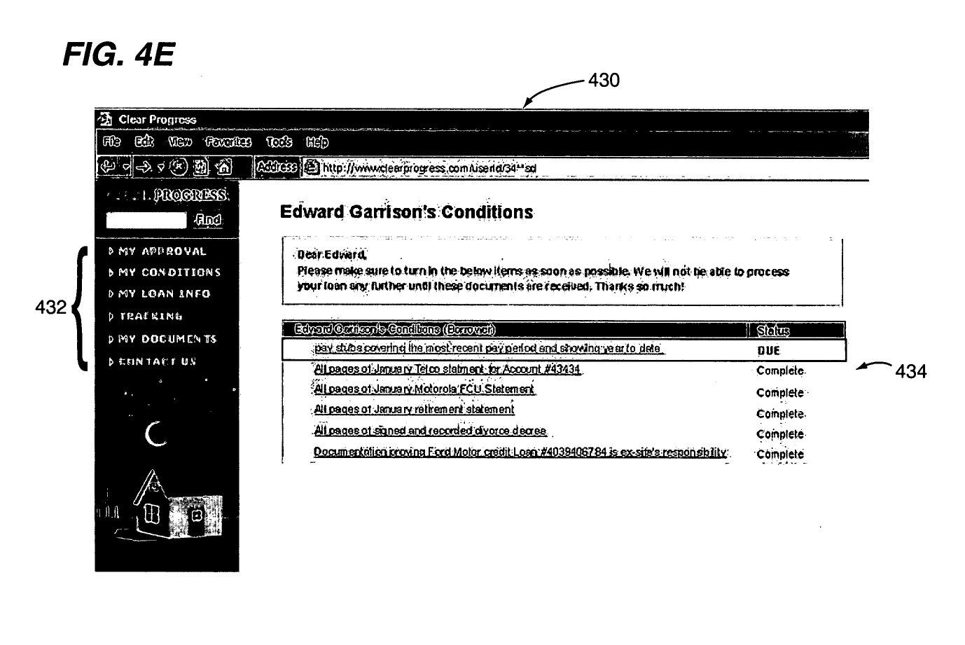

Turning now to collaborative transaction management functionality in accordance with an embodiment of the inventive disclosures made herein, a network-based collaborative transaction management arrangement configured for supporting workflow management functionality is depicted in FIGS. 4A through 4E. In one embodiment, a collaborative transaction management module in accordance with the inventive disclosures made herein implements the network-based collaborative transaction management arrangement. Through the website structure, transaction parties that are internal to and external to the mortgage company are enabled access to information associated with the workflow management of residential home mortgage transaction tasks.

Referring to FIG. 4A, an embodiment of a mortgage administrator (e.g., mortgage officer, mortgage processor, etc) webpage structure 402 is depicted. Through the mortgage administrator webpage structure 402, the mortgage administrator officer can access workflow information and collaborative transaction information required for progressing a mortgage from origination through funding. The mortgage administrator webpage structure 402 includes a plurality of webpage selections 404 for enabling access to webpages comprising corresponding workflow management information. Examples of such webpages include a Dashboard page for accessing key summary information for each outstanding mortgage, a Tasks page for accessing completed and outstanding transaction management tasks for each outstanding mortgage, a Contacts page for accessing contacts associated with performing the transaction management tasks, a Received Documents page for accessing documents received for each outstanding mortgage, a Tracking Item page for accessing tracking information for each outstanding mortgage, a Sent E-Mail page for accessing previously sent e-mail and a Reports page for accessing system-generated mortgage/workflow reports.

As depicted in FIG. 4A, the Dashboard page is activated. The Dashboard page includes a listing 406 of open mortgages and a listing 408 of overdue tasks. Mortgages (e.g., mortgage tasks that require immediate attention are highlighted (e.g., have a box surrounding them or displayed in a color specifically designating them). In one embodiment, the Dashboard page is advantageously the default page that is displayed, thus allowing the mortgage administrator to immediately scan their open mortgage, overdue items and any critical tasks associated therewith.

An embodiment of the Tracking page is depicted in FIG. 4B. Tracking information is provided each open mortgage. Examples of such tracking information include a description 410 of the pending and completed tasks, a name 412 of the transaction party responsible for facilitating each task, a name 414 of the mortgage administrator responsible for the mortgage, a status 416 of each task, a due date 418 for each task, a selection 420 for initiating ordering of a work-product associated with each task and a selection 422 for enabling viewing of a document (e.g., a received work-product) associated with completed task.

An embodiment of an electronically transmitted work-product order 424 is depicted in FIG. 4C. The work-product order 424 includes information required for a designated service provider to generate the desired work-product and submit the completed work product to the mortgage administrator. Examples of such information required for a designated service provider to generate the desired work-product and submit the completed work product to the mortgage administrator include mortgage information due date information and mode of submittal information. In one embodiment, similarly configured reminder notices and overdue notices are transmitted in accordance with prescribed workflow management rules, as necessary to facilitate timely completion of the work-product. Examples of work-products include wiring instructions, insured closing letter, title commitment, tax certification, appraisal, flood certification, survey and hazard insurance binder.

An embodiment of an electronically transmitted introduction notification 426 is depicted in FIG. 4D. The introduction notification 426 includes information for introducing transaction parties to the collaborative transaction management process and enabling access to corresponding content. In one embodiment, the introduction notification includes access information 428 (e.g., a log-in page link, a system-assigned user name and a system assigned passcode), thus enabling the recipient of the notification (e.g., a listing real estate agent, a selling real estate agent, an applicant, etc) to access a respective system-managed webpage structure.

An embodiment of an applicant webpage structure 430 is depicted in FIG. 4E. Through the applicant webpage structure 430, the applicant can access workflow information and collaborative transaction information required for progressing a mortgage from origination through funding. The applicant webpage structure 430 includes a plurality of webpage selections 432 for enabling access to webpages comprising corresponding workflow management information and collaborative transaction information. Examples of such webpages include a my approval page for accessing mortgage approval information, a My Conditions page for accessing conditions that must be met in accordance with the mortgage approval, a My Loan Information page for accessing detailed mortgage information, a Tracking page for accessing tracking information and a My Documents page for accessing mortgage documents.

As depicted in FIG. 4E, the My Conditions page is activated. The My Conditions page includes a listing 434 of completed and pending workflow tasks for the applicant's mortgage. Tasks that require immediate attention are highlighted (e.g., have a box surrounding them or displayed in a color specifically designating them). It is contemplated and disclosed herein that webpage structures similar in content and context to the applicant webpage structure may be provided for other transaction parties (e.g., the listing real estate agent, the selling real estate agent, etc).

Referring now to computer readable medium in accordance with an embodiment of the disclosures made herein, methods, processes and/or operations as disclosed herein for enabling disclosed automated workflow and collaborative transaction management functionalities are tangibly embodied by computer readable medium having instructions thereon for carrying out such methods, processes and/or operations. In one specific example, instructions are provided for carrying out the various operations of the methods, processed and/or operations depicted in FIGS. 3A-3D and/or associated with the system 200 depicted in FIG. 2. The instructions may be accessible by one or more data processing devices of a system as disclosed herein (i.e., a server) from a memory apparatus of the computer system (e.g. RAM, ROM, flash memory, virtual memory, hard drive memory, etc). Examples of computer readable medium include a compact disk or a hard drive, which has imaged thereon a computer program adapted for carrying out disclosed automated workflow and collaborative transaction management functionalities. Java is an example of a language suitable for such instructions. However, use of other known program languages is contemplated and deemed to be suitable for such instructions. Selection of the actual language will at least partially be based on programmer and/or system preferences.

In summary, methods, systems and/or software in accordance with embodiments of the inventive disclosures made herein include web-based functionality (e.g., via appropriately configured hardware) that automates the aggregation and dissemination of information to participants (i.e., transaction parties) involved in typical residential real estate transactions. Preferably, such methods, systems and/or software are configured for interfacing with data processing systems of service providers (e.g., the automated underwriting platforms of Fannie Mae and/or Freddie Mac) that provide required work-products and are configured for providing such service providers with access (e.g., via a network) to system-managed information necessary for providing required work-product orders.

Methods, systems and/or software in accordance with embodiments of the inventive disclosures made herein automate the workflow involved in originating, processing, closing and funding residential home mortgages by programmatically creating, scheduling, tracking and executing workflow related tasks for the disparate participants involved. In addition to automatic task creation, third party services and orders are programmatically ordered and tracked on behalf of mortgage administrators.

In one embodiment, such methods, systems and/or software provide appropriate participants with an electronic dashboard that displays a listing of every pending transaction in their pipeline of business and lists respective tasks owned by each party for each transaction listed therein. Any mortgage or task listed on the dashboard that requires action is displayed in a color (e.g., red), alerting the participant that action is needed.

Methods, systems and/or software in accordance with embodiments of the inventive disclosures made herein maximize efficiency and productivity of mortgage brokerages while enabling them to deliver superior customer service to the borrower and the realtors that refer business to the brokerage. Such methods, systems and/or software allow brokerages to administer more mortgages with significantly fewer errors and oversights. Rather than sifting through thousands of pieces of paper to garnish information and determine that status of pending transactions, brokerage personnel (e.g., mortgage originators and processors) access system-managed network-based information to determine which mortgages need action/attention. Furthermore, other participants such as the borrower and realtors are provided with access to appropriate and necessary portion of such system-managed, network-based information through any Internet-enables computer having a standard web browser running thereon. For example, realtors involved in facilitating a mortgage for a homebuyer are relieved from imposed workflow management responsibilities (i.e., making sure workflow is progressing) through implementation of the novel and distinguishing features and functionality disclosed herein (e.g., system-managed work spaces, collaborative communication, network-based information access, etc).

It is contemplated and disclosed herein that methods, systems and/or software in accordance with embodiments of the inventive disclosures made herein include one or more features that provide enhancing, advantageous and distinguishing functionality relative to the disclosures made above. Representation of every paper document produced by lender (e.g., application, good faith estimate, etc) in extensible mark-up language (XML) is one example of such features. Wireless interface for enabling access via handheld mobile/portable devices is another example of such features. Automated prospect management of business prospects (e.g., realtors, borrowers, title companies, etc) such as via automated email and/or fax campaigns, automated voice call/meeting scheduling and the like is another example of such features. Enabling realtors and/or mortgage company personnel to input and maintain referral contact information via web-based access and programmatically managing and/or conducting lead prospecting is another example of such features. System-integrated messaging functionality (e.g., instant messaging) such as for notifying mortgage administrators when realtors and/or borrowers access system-managed information is another example of such features. System-managed discussion (e.g., threaded bulletin board within network accessible forums) that allows transaction parties to discuss multiple mortgage-related topics from inception through resolution is another example of such features. A system-managed/maintained history database that contains historical/archive information (e.g., mortgage transaction information, instant message information, threaded discussion information, email information, phone call information, work-product information, etc) is another example of such features. System-managed distribution of referral requests from the mortgage company to realtors and applications and from realtors to respective applicants (e.g., realtor branded notices and/or mortgage company brand notices), which are sent for example prior to closing the mortgage, is another example of such features. Facilitating such referrals prior to closing is advantageous in that the exceptional quality of service of the mortgage company and realtors, as enabled by the system and/or method as disclosed herein, is still fresh on the minds of the recipients of such referral requests.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A system for facilitating residential home mortgage transactions, comprising:
a workflow management module configured for implementing workflow management of residential home mortgage transaction tasks dependent upon at least one of workflow states of said residential home mortgage transaction tasks and prescribed workflow management rules; and
a collaborative transaction management module coupled to said workflow management module for enabling interaction between said modules and configured for implementing access to system-managed workflow information by designated transaction parties dependent upon at least one of said workflow states of said residential home mortgage transaction tasks, said prescribed workflow management rules and prescribed collaborative transaction management rules.

2. The system of claim 1 wherein said residential home mortgage transaction tasks include at least a portion of receiving residential home mortgage application information, verifying said residential home mortgage application information for completeness, requesting required residential home mortgage application information, requesting a sales contract, ordering work-product from designated service providers, receiving said workflow products, compiling mortgage approval and disclosure kit components, transmitting mortgage approval and disclosure kit components for reception by a mortgage applicant and preparing a mortgage approval certificate.

3. The system of claim 1 wherein said residential home mortgage transaction tasks include tasks comprised by originating a mortgage application, tasks comprised by processing a residential home mortgage application, tasks comprised by closing a mortgage, and tasks comprised by funding a mortgage.

4. The system of claim 1 wherein facilitating said residential home mortgage transaction tasks includes:
generating a mortgage document in accordance with said workflow management rules, wherein the mortgage document includes a barcode that designates a unique identity of the mortgage document; and
scanning the barcode for determining an identity of the mortgage document in response to receiving a copy of the mortgage document after generating the mortgage document.

5. The system of claim 1 wherein the workflow management module is configured for interacting with service-provider data processing systems whereby at least a portion of said residential home mortgage transaction task are facilitated without human intervention.

6. The system of claim 5 wherein interacting with said service-provider processing systems includes:
requesting a work-product from said service-provider processing system in accordance with said workflow management rules; and
receiving the work-product from said service-provider processing system.

7. The system of claim 6 wherein:
said requesting the work-product includes providing information required for generating a bar-code on the mortgage document that designates a unique identity of the mortgage document; and
said receiving work-product includes scanning the barcode for determining an identity of the mortgage document.

8. The system of claim 1 wherein said implementing access to system-managed workflow information includes at least one of:
transmitting an collaborative transaction management information for reception by an electronic mail account of at least a portion of said designated transaction parties; and
enabling access to said system-managed workflow information by at least a portion of said designated transaction parties through a computer network interface.

9. The system of claim 8 wherein said system-managed workflow information includes at least one of notification of ordering of service-provider work-product, notification of receipt of said service-provider work-product and mortgage status information.

10. The system of claim of claim 1 wherein:
said workflow states includes a state corresponding to overdue information; and
a corresponding one of said prescribed workflow management rules is a rule designating that an information request notification be transmitted for reception by a designated one of said designated transaction parties having responsibility for providing said overdue information.

11. The system of claim 1 wherein said implementing access to system-managed workflow information includes enabling said system-managed workflow information to be accessed via a network connection.

12. The system of claim 1 wherein said prescribed workflow management rules include:
rules defining relative scheduling upon which said residential home mortgage transaction tasks are performed; and
rules defining successful completion of each one of said residential home mortgage transaction tasks.

13. The system of claim 12 wherein said prescribed collaborative transaction management rules include rules designating portions of said designated transaction parties for which access to said system-managed workflow information is enabled when corresponding ones of said residential home mortgage transaction tasks are successfully completed.

14. The system of claim 13 wherein said system-managed workflow information includes at least one of notification of ordering of service-provider work-product, notification of receipt of said service-provider work-product and mortgage status information.

15. The system of claim 1 wherein said prescribed collaborative transaction management rules include rules designating portions of said designated transaction parties for which access to said system-managed workflow information is enabled when corresponding ones of said residential home mortgage transaction tasks are successfully completed.

16. The system of claim 15 wherein said system-managed workflow information includes at least one of notification of ordering of service-provider work-product, notification of receipt of said service-provider work-product and mortgage status information.

17. A system for facilitating residential home mortgage transactions, comprising:
a workflow management module configured for implementing workflow management of residential home mortgage transaction tasks dependent upon at least one of workflow states of said residential home mortgage transaction tasks and prescribed workflow management rules, wherein facilitating said residential home mortgage transaction tasks includes generating a mortgage document in accordance with said workflow management rules, wherein the mortgage document includes a barcode that designates a unique identity of the mortgage document and scanning the barcode for determining an identity of the mortgage document in response to receiving a copy of the mortgage document after generating the mortgage document; and
an collaborative transaction management module coupled to said workflow management module for enabling interaction between said modules and configured for implementing access to system-managed workflow information by designated transaction parties dependent upon at least one of said workflow states of said residential home mortgage transaction tasks, said prescribed workflow management rules and prescribed collaborative transaction management rules, wherein said implementing access to system-managed information includes at least one of transmitting an collaborative transaction management information for reception by an electronic mail account of at least a portion of said designated transaction parties and enabling access to said system-managed information by at least a portion of said designated transaction parties through a computer network interface.

18. The system of claim 17 wherein the workflow management module is configured for interacting with service-provider data processing systems whereby at least a portion of said residential home mortgage transaction task are facilitated without human intervention.

19. The system of claim 18 wherein interacting with said service-provider processing systems includes:
requesting a work-product from said service-provider processing system in accordance with said workflow management rules; and
receiving the work-product from said service-provider processing system.

20. The system of claim 17 wherein said system-managed workflow information includes at least one of notification of ordering of service-provider work-product, notification of receipt of said service-provider work-product and mortgage status information.

21. The system of claim of claim 17 wherein:
said workflow states includes a state corresponding to overdue information; and
a corresponding one of said prescribed workflow management rules is a rule designating that an information request notification be transmitted for reception by a designated one of said designated transaction parties having responsibility for providing said overdue information.

22. The system of claim 17 wherein said prescribed workflow management rules include:
rules defining relative scheduling upon which said residential home mortgage transaction tasks are performed; and
rules defining successful completion of each one of said residential home mortgage transaction tasks.

23. The system of claim 22 wherein said prescribed collaborative transaction management rules include rules designating portions of said designated transaction parties for which access to said system-managed workflow information is enabled when corresponding ones of said residential home mortgage transaction tasks are successfully completed.

24. The system of claim 17 wherein said prescribed collaborative transaction management rules include rules designating portions of said designated transaction parties for which access to said system-managed workflow information is enabled when corresponding ones of said residential home mortgage transaction tasks are successfully completed.

25. A computer-implemented method for facilitating residential home mortgage transactions, comprising:
implementing workflow management of residential home mortgage transaction tasks dependent upon at least one of workflow states of said residential home mortgage transaction tasks and prescribed workflow management rules; and
implementing access to system-managed workflow information by designated transaction parties dependent upon at least one of said workflow states of said residential home mortgage transaction tasks, said prescribed workflow management rules and prescribed collaborative transaction management rules.

26. The method of claim 25 wherein said residential home mortgage transaction tasks include at least a portion of receiving mortgage application information, verifying said mortgage application information for completeness, requesting required mortgage application information, requesting a sales contract, ordering work-product from designated service providers, receiving said workflow products, compiling mortgage approval and disclosure kit components, transmitting mortgage approval and disclosure kit components for reception by a mortgage applicant and preparing a mortgage approval certificate.

27. The method of claim 25 wherein said residential home mortgage transaction tasks include tasks comprised by originating a mortgage application, tasks comprised by processing a mortgage application, tasks comprised by closing a mortgage, and tasks comprised by funding a mortgage.

28. The method of claim 25 wherein facilitating said residential home mortgage transaction tasks includes:
generating a mortgage document in accordance with said workflow management rules, wherein the mortgage document includes a barcode that designates a unique identity of the mortgage document; and
scanning the barcode for determining an identity of the mortgage document in response to receiving a copy of the mortgage document after generating the mortgage document.

29. The method of claim 25 wherein said implementing workflow management of residential home mortgage transaction tasks includes interacting with service-provider data processing systems whereby at least a portion of said residential home mortgage transaction task are facilitated without human intervention.

30. The method of claim 29 wherein said interacting with said service-provider processing systems includes:
requesting a work-product from said service-provider processing system in accordance with said workflow management rules; and
receiving the work-product from said service-provider processing system.

31. The method of claim 30 wherein:
said requesting the work-product includes providing information required for generating a bar-code on the mortgage document that designates a unique identity of the mortgage document; and
said receiving work-product includes scanning the barcode for determining an identity of the mortgage document.

32. The method of claim 25 wherein said implementing access to system-managed workflow information includes at least one of:
transmitting an collaborative transaction management information for reception by an electronic mail account of at least a portion of said designated transaction parties; and
enabling access to said system-managed workflow information by at least a portion of said designated transaction parties through a computer network interface.

33. The method of claim 32 wherein said system-managed workflow information includes at least one of notification of ordering of service-provider work-product, notification of receipt of said service-provider work-product and mortgage status information.

34. The method of claim of claim 25 wherein:
said workflow states includes a state corresponding to overdue information; and
a corresponding one of said prescribed workflow management rules is a rule designating that an information request notification be transmitted for reception by a designated one of said designated transaction parties having responsibility for providing said overdue information.

35. The method of claim 25 wherein said prescribed workflow management rules include:
rules defining relative scheduling upon which said residential home mortgage transaction tasks are performed; and
rules defining successful completion of each one of said residential home mortgage transaction tasks.

36. The method of claim 35 wherein said prescribed collaborative transaction management rules include rules designating portions of said designated transaction parties for which access to said system-managed workflow information is enabled when corresponding ones of said residential home mortgage transaction tasks are successfully completed.

37. The method of claim 36 wherein said system-managed workflow information includes at least one of notification of ordering of service-provider work-product, notification of receipt of said service-provider work-product and mortgage status information.

38. A computer-implemented method for facilitating residential home mortgage transactions, comprising:
implementing workflow management of residential home mortgage transaction tasks dependent upon at least one of workflow states of said residential home mortgage transaction tasks and prescribed workflow management rules, wherein facilitating said residential home mortgage transaction tasks includes generating a mortgage document in accordance with said workflow management rules, wherein the mortgage document includes a barcode that designates a unique identity of the mortgage document and scanning the barcode for determining an identity of the mortgage document in response to receiving a copy of the mortgage document after generating the mortgage document; and
implementing access to system-managed workflow information by designated transaction parties dependent upon at least one of said workflow states of said residential home mortgage transaction tasks, said prescribed workflow management rules and prescribed collaborative transaction management rules, wherein said implementing access to system-managed workflow information includes at least one of transmitting an collaborative transaction management information for reception by an electronic mail account of at least a portion of said designated transaction parties and enabling access to said system-managed workflow information by at least a portion of said designated transaction parties through a computer network interface.

39. The method of claim 38 wherein said implementing workflow management of residential home mortgage transaction tasks includes interacting with service-provider data processing systems whereby at least a portion of said residential home mortgage transaction task are facilitated without human intervention.

40. The method of claim 39 wherein interacting with said service-provider processing systems includes:
requesting a work-product from said service-provider processing system in accordance with said workflow management rules; and
receiving the work-product from said service-provider processing system.

41. A computer system, comprising:
at least one data processing device;
instructions processable by said at least one data processing device; and
an apparatus from which said instructions are accessible by said at least one data processing device;
wherein said instructions are configured for enabling said at least one data processing device to facilitate:
implementing workflow management of residential home mortgage transaction tasks dependent upon at least one of workflow states of said residential home mortgage transaction tasks and prescribed workflow management rules; and
implementing access to system-managed workflow information by designated transaction parties dependent upon at least one of said workflow states of said residential home mortgage transaction tasks and prescribed collaborative transaction management rules.

42. The computer system of claim 41 wherein said residential home mortgage transaction tasks include at least a portion of receiving mortgage application information, verifying said mortgage application information for completeness, requesting required mortgage application information, requesting a sales contract, ordering work-product from designated service providers, receiving said workflow products, compiling mortgage approval and disclosure kit components, transmitting mortgage approval and disclosure kit components for reception by a mortgage applicant and preparing a mortgage approval certificate.

43. The computer system of claim 41 wherein said residential home mortgage transaction tasks include tasks comprised by originating a mortgage application, tasks comprised by processing a mortgage application, tasks comprised by closing a mortgage, and tasks comprised by funding a mortgage.

44. The computer system of claim 41 wherein facilitating said residential home mortgage transaction tasks includes:
generating a mortgage document in accordance with said workflow management rules, wherein the mortgage document includes a barcode that designates a unique identity of the mortgage document; and
scanning the barcode for determining an identity of the mortgage document in response to receiving a copy of the mortgage document after generating the mortgage document.

45. The computer system of claim 41 wherein said implementing workflow management of residential home mortgage transaction tasks includes interacting with service-provider data processing systems whereby at least a portion of said residential home mortgage transaction task are facilitated without human intervention.

46. The computer system of claim 45 wherein said interacting with said service-provider processing systems includes:
requesting a work-product from said service-provider processing system in accordance with said workflow management rules; and
receiving the work-product from said service-provider processing system.

47. The computer system of claim 46 wherein:
said requesting the work-product includes providing information required for generating a bar-code on the mortgage document that designates a unique identity of the mortgage document; and
said receiving work-product includes scanning the barcode for determining an identity of the mortgage document.

48. The computer system of claim 41 wherein said implementing access to system-managed workflow information includes at least one of:
transmitting an collaborative transaction management information for reception by an electronic mail account of at least a portion of said designated transaction parties; and
enabling access to said system-managed workflow information by at least a portion of said designated transaction parties through a computer network interface.

49. The computer system of claim 48 wherein said system-managed workflow information includes at least one of notification of ordering of service-provider work-product, notification of receipt of said service-provider work-product and mortgage status information.

50. The computer system of claim of claim 41 wherein:
said workflow states includes a state corresponding to overdue information; and
a corresponding one of said prescribed workflow management rules is a rule designating that an information request notification be transmitted for reception by a designated one of said designated transaction parties having responsibility for providing said overdue information.

51. The computer system of claim 41 wherein said prescribed workflow management rules include:
rules defining relative scheduling upon which said residential home mortgage transaction tasks are performed; and
rules defining successful completion of each one of said residential home mortgage transaction tasks.

52. The computer system of claim 51 wherein said prescribed collaborative transaction management rules include rules designating portions of said designated transaction parties for which access to said system-managed workflow information is enabled when corresponding ones of said residential home mortgage transaction tasks are successfully completed.

53. The computer system of claim 52 wherein said system-managed workflow information includes at least one of notification of ordering of service-provider work-product, notification of receipt of said service-provider work-product and mortgage status information.

54. A computer system, comprising:
at least one data processing device;
instructions processable by said at least one data processing device; and
an apparatus from which said instructions are accessible by said at least one data processing device;
wherein said instructions are configured for enabling said at least one data processing device to facilitate:
implementing workflow management of residential home mortgage transaction tasks dependent upon at least one of workflow states of said residential home mortgage transaction tasks and prescribed workflow management rules, wherein facilitating said residential home mortgage transaction tasks includes generating a mortgage document in accordance with said workflow management rules, wherein the mortgage document includes a barcode that designates a unique identity of the mortgage document and scanning the barcode for determining an identity of the mortgage document in response to receiving a copy of the mortgage document after generating the mortgage document; and
implementing access to system-managed workflow information by designated transaction parties dependent upon at least one of said workflow states of said residential home mortgage transaction tasks, said prescribed workflow management rules and prescribed collaborative transaction management rules, wherein said implementing access to system-managed workflow information includes at least one of transmitting an collaborative transaction management information for reception by an electronic mail account of at least a portion of said designated transaction parties and enabling access to said system-managed workflow information by at least a portion of said designated transaction parties through a computer network interface.

55. The computer system of claim 54 wherein said implementing workflow management of residential home mortgage transaction tasks includes interacting with service-provider data processing systems whereby at least a portion of said residential home mortgage transaction task are facilitated without human intervention.

56. The computer system of claim 55 wherein interacting with said service-provider processing systems includes:
requesting a work-product from said service-provider processing system in accordance with said workflow management rules; and
receiving the work-product from said service-provider processing system.
